(19) United States
(12) Patent Application Publication
(10) Pub. No.: US 2026/0300997 A1
(43) Pub. Date: Oct. 1, 2026

(54) METHOD AND SYSTEM FOR ANALYZING GOVERNANCE AND COMPLIANCE CONFORMANCE OF PRODUCTS

(71) Applicant: HCL Technologies Limited, New Delhi (IN)

(72) Inventors: Veera Venkata Paparao Gokavarapu, Bangalore (IN); Sudhindra Srinivasa Paraki, Bangalore (IN); Mythilinath Venkata Satya Narasimhadevara, Bangalore (IN); Ashish Goyal, Bangalore (IN)

(21) Appl. No.: 19/444,279

(22) Filed: Jan. 9, 2026

(30) Foreign Application Priority Data
Mar. 31, 2025 (IN) 202511032056

(51) Int. Cl. G06Q 30/018

(52) U.S. Cl. CPC G06Q 30/018

(57) ABSTRACT

Disclosed herein, method and system for analyzing governance and compliance conformance of products. The method may include receiving a first set of data vectors representative of a user response to a self-evolving questionnaire. The method may further include normalizing the first set of data vectors to generate a set of normalized data vectors. The method may further include comparing a second set of data vectors associated with a data repository from the set of data repositories with the set of normalized data vectors. The method may further include retrieving a subset of the second set of data vectors based on a result of the comparing.

### TECHNICAL FIELD

This disclosure generally relates to security governance and compliance. More particularly to method and system for analyzing governance and compliance conformance of products.

### BACKGROUND

With the introduction of advanced development tools and machines, expectation with regards to the speed of production of product has increased. With such an expectation of increase in the pace of production, an organization developing a product may fail to use the relevant tools based on the predefined industry standards. Moreover, any product before deployment may need to comply with security governance and security compliance required for compliance with security strategy. Further, such an organization may be required to follow security guidelines in order to prevent unauthorized access to the product and to comply with privacy requirements of the product. Security governance involves coordination across organization's employee, vendor, hardware, software and policies, while security compliance outlines the framework and a method for the organization to follow so that the product aligns with business objectives and regulatory requirements. Security governance also includes establishing policies, risk management strategies, accountability and continuous improvement strategies, or the like, while security compliance incorporates following laws, regulations, and industry standards for the organization.

There may be a lot of variance with respect to requirement of security governance and compliance for different products and different organizations based on their location. However, the existing techniques are not configured to produce a product compliant to specific security governance and compliance. Moreover, the existing techniques may not be able to verify compliance of the product as per the security governance and compliance requirements.

There is, therefore, a need for a flexible and consistent method and system that ensure compliance of product with specific security governance and compliance requirements.

### SUMMARY

In one embodiment, a method for analyzing governance and compliance conformance of products is disclosed. In one example, the method may include receiving a first set of data vectors representative of a user response to a self-evolving questionnaire. The user response corresponds to a product. The method may further include normalizing the first set of data vectors to generate a set of normalized data vectors. The set of normalized data vectors may include a first set of dimensions. The method may further include comparing a second set of data vectors associated with a data repository from the set of data repositories with the set of normalized data vectors. The second set of data vectors corresponds to a predefined set of compliance policies and a predefined set of industry standards. The method may further include retrieving a subset of the second set of data vectors based on a result of the comparison. The subset of the second set of data vectors may correspond to a subset of compliance policies and a subset of industry standards associated with the data repository. The product fails to comply with the subset of compliance policies and the subset of industry standards.

In another embodiment, a system for analyzing governance and compliance conformance of products is disclosed. In one example, the system may include a processor, and a memory communicatively coupled to the processor. The memory may store processor-executable instructions, which, on execution, may cause the processor to receive a first set of data vectors representative of a user response to a self-evolving questionnaire. The user response corresponds to a product. The processor-executable instructions, on execution, may further cause the processor to normalize the first set of data vectors to generate a set of normalized data vectors. The set of normalized data vectors includes a first set of dimensions. The processor-executable instructions, on execution, may further cause the processor to compare a second set of data vectors associated with a data repository from the set of data repositories with the set of normalized data vectors. The second set of data vectors corresponds to a predefined set of compliance policies and a predefined set of industry standards. The processor-executable instructions, on execution, may further cause the processor to retrieve a subset of second set of data vectors based on a result of the comparison. The subset of the second set of data vectors may correspond to a subset of compliance policies and a subset of industry standards associated with the data repository. The product fails to comply with the subset of compliance policies and the subset of industry standards.

In yet another embodiment, a non-transitory computer-readable medium storing computer-executable instructions for analyzing governance and compliance conformance of products is disclosed. In one example, the stored instructions, when executed by a processor, may cause the processor to perform operations including, receiving a first set of data vectors representative of a user response to a self-evolving questionnaire. The user response corresponds to a product. The operations may further include normalizing the first set of data vectors to generate a set of normalized data vectors. The set of normalized data vectors includes a first set of dimensions. The operations may further include comparing a second set of data vectors associated with a data repository from the set of data repositories with the set of normalized data vectors. The second set of data vectors corresponds to a predefined set of compliance policies and a predefined set of industry standards. The operations may further include retrieving a subset of the second set of data vectors based on a result of the comparison. The subset of the second set of data vectors may correspond to a subset of compliance policies and a subset of industry standards associated with the data repository. The product fails to comply with the subset of compliance policies and the subset of industry standards.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for analyzing governance and compliance conformance of products, in accordance with some embodiments of the present disclosure.

FIG. 2 illustrates a functional block diagram of various modules within a memory of the computing device configured to analyze governance and compliance conformance of products, in accordance with some embodiments of the present disclosure.

FIG. 3 illustrates a flowchart of a method for analyzing governance and compliance conformance of products, in accordance with some embodiments of the present disclosure.

FIG. 4 illustrates a detailed flowchart of an exemplary method for comparing a second set of data vectors associated with a data repository from the set of data repositories with the set of normalized data vectors, in accordance with some embodiments of the present disclosure.

FIG. 5 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

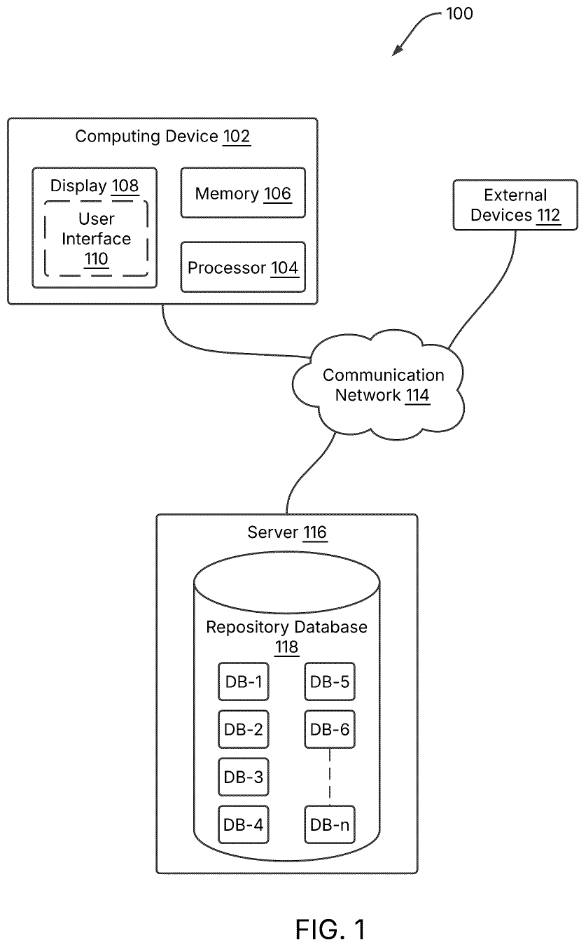

Referring now to FIG. 1, a block diagram of an exemplary system 100 for analyzing governance and compliance conformance of products is illustrated, in accordance with some embodiments of the present disclosure. The system 100 may include a computing device 102, which, for example, may be, but is not limited to a server, a desktop, a laptop, a notebook, a netbook, a tablet, a smartphone, a mobile phone, or any other computing device. The computing device 102 may implement a method for analyzing governance and compliance conformance of products. The computing device 102 may also generate a report that includes a conformance rating for the product with respect to governance and compliance requirements, which may be related to security governance and compliance. The report may also include recommendations and details as to how a predefined rating (ideal rating) can be achieved.

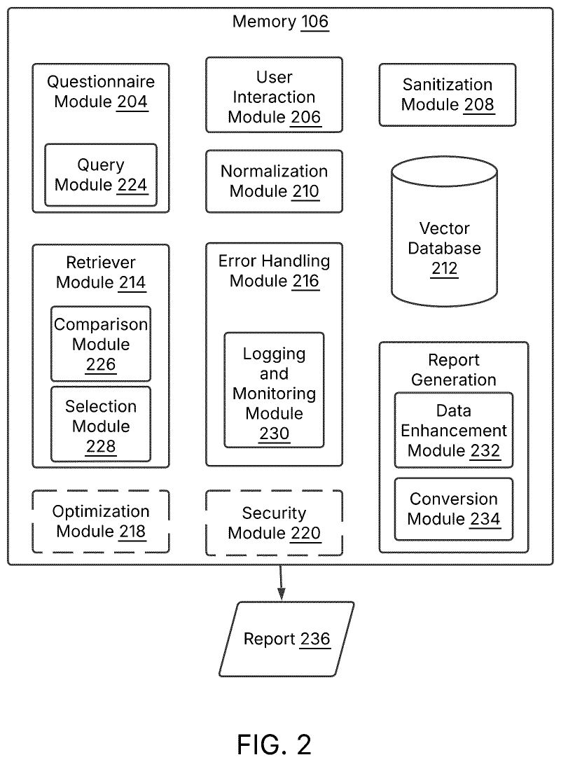

As will be described in greater detail in conjunction with FIG. 2-FIG. 5, the computing device 102 may receive a first set of data vectors representative of a user response to a self-evolving questionnaire. The self-evolving questionnaire may be to capture information related toa product, and thus the user response may correspond to a specific product. It may be noted that the user response may be converted to the first set of data vectors. The computing device 102 may further normalize the first set of data vectors to generate a set of normalized data vectors. The set of normalized data vectors may also include a first set of dimensions. The first set of dimensions may include, but is not limited to country, state, domain, or industry associated with the product.

Based on the set of dimensions, the computing device 102 may select a data repository from the set of data repositories. The computing device 102 may then compare a second set of data vectors associated with the data repository with the set of normalized data vectors. The second set of data vectors may correspond to a first predefined set of compliance policies and a first predefined set of industry standards. The compliance policies and industry standards correspond to the security governance and compliance policies. Based on a result of the comparison, the computing device 102 may retrieve a subset of the second set of data vectors. The subset of the second set of data vectors may correspond to a subset of compliance policies and a subset of industry standards associated with the data repository. The product fails to comply with these subset of compliance policies and the subset of industry standards. In other words, for a given product, the computing device 102 identifies subset of compliance policies and the subset of industry standards that the product fails to comply with.

In order to perform the aforementioned steps, the computing device 102 may include a processor 104 and a memory 106. The memory 106 may store instructions that, when executed by the processor 104, cause the processor 104 to analyse governance and compliance conformance of products, in accordance with aspects of the present disclosure. The memory 106 may also store various data (for example, the first set of data vectors, the set of normalized data vectors, the second set of data vectors, the set of data repositories, and the like) that may be captured, processed, and/or required by the system 100. The memory 106 may be a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random Access Memory (DRAM), Static Random-Access memory (SRAM), etc.).

The computing device 102 may further include a display 108. A user may interact with the computing device 102 via a user interface 110 accessible via the display 108. The system 100 may also include one or more external devices 112 and the computing device 102 may interact with the one or more external devices 112 over a communication network 114 for sending or receiving various data. The communication network 114, for example, may include, but may not be limited to, a Wireless Fidelity (Wi-Fi) network, a Light Fidelity (Li-Fi) network, a Local Area Network (LAN), a Wide Area Network (WAN), a Metropolitan Area Network (MAN), a satellite network, the internet, a fiber optic network, a coaxial cable network, an infrared (IR) network, a Radio Frequency (RF) network, or a combination thereof. The one or more external devices 112 may include, but may not be limited to a remote server, a laptop, a netbook, a notebook, a smartphone, a mobile phone, a tablet, or any other computing device. The system 100 may also interact with a server 116 that may include a repository database 118. The repository database 118 may include a set of databases (DB-1 to DB-n) each of which correspond to one of the set of data repositories. By way of an example, the database DB-1 may include the second set of data vectors associated with a first data repository.

Referring now to FIG. 2, a functional block diagram of various modules within the memory 106 of the computing device 102 configured to analyze governance and compliance conformance of products is illustrated, in accordance with some embodiments of the present disclosure. FIG. 2 is explained in conjunction with FIG. 1. The memory 106 may include a questionnaire module 204, a user interaction module 206, a sanitization module 208, a normalization module 210, a vector database 212, a retriever module 214, an error handling module 216, an optimization module 218, a security module 220, and a report generation module 222. One or more of the modules 204-222 may further include additional modules. In current embodiment, the questionnaire module 204 may include a query module 224, the retriever module 214 may include a comparison module 226 and a selection module 228, the error handling module 216 may include a logging and monitoring module 230, and the report generation module 222 may include a data enhancement module 232 and a conversion module 234.

In an exemplary scenario, a user may access the computing device 102 either directly or via a user device (not shown in figure). The user device, for example, may be, but is limited to a server, a desktop, a laptop, a notebook, a netbook, a tablet, a smartphone, a mobile phone, or any other computing device.

The questionnaire module 204 may provide a set of questions to the user. The set of questions may be presented in the form of a self-evolving questionnaire. In other words, the set of questions are not provided to the user at once, but a follow-up question may be generated based on a user response to the previous question. The set of questions are generated to obtain data associated with a product in order to analyze the governance and compliance conformance of the product with a predefined set of compliance policies and a predefined set of industry standards. In some embodiments, the query module 224 of the questionnaire module 204 may include a predefined Machine Learning algorithm to generate the follow-up question upon receiving the user response for the previous question. The data associated with the product may include information, for example, but not limited to geographical location, industry, domain, technology, or the like.

The set of questions may include but are not limited to a factual (or straightforward) question, a multiple-choice question or the like. For example, the set of questions may include interrogative sentences (such as queries that begin with words or phrases like “what”, “when”, “does”, “do”, etc.). By way of an example, the self-evolving questionnaire for an exemplary product, may include the following questions, not necessarily in the same order:
Which country will your product be shipped to?
What technology is used for product development?
Which industry utilizes this product?
What is the core domain of the product?
Does the product work on desktop, web, or both?
Does this product use client-server communication?
Do you use a secure connection for client-server communication?
Does the product run on multiple platforms (Windows, Linux, Apple)?
Do you support wireless communication?
Is the product embedded in humans?
Do you follow ISO 27001, ISO 27002, NIST CSF, or any other cybersecurity standard?

The user interaction module 206 may provide the user with an interactive interface on the device in order to display the self-evolving questionnaire. The user interaction module 206 may render the self-evolving questionnaire via the UI 110 of the display 108 or a display of the user device being used by the user. The data retrieved by the questionnaire module 224 and the user interaction module 206 may be converted to a first set of data vectors. It will be apparent that the first set of data vectors is representative of the user response to the self-evolving questionnaire. The first set of data vectors may be stored in the vector database 212.

The sanitization module 208 may be used to clean the first set of data vectors. The method of cleaning may include deletion of duplicate data vectors, deletion of data vectors that include sensitive data or the like. The sanitization module 208 may be used to achieve the consistency in the first set of data vectors. Upon receiving the sanitized first set of data vectors, the normalization module 210 may normalize the first set of data vectors. The normalization techniques may include min-max normalization, max-abs normalization, mean normalization, z-score normalization, or the like. A normalized set of data vectors is then stored in the vector database 212.

The set of normalized data vectors may then be fed into the retriever module 214. The set of normalized data vectors may also include a first set of dimensions. The selection module 228 in the retriever module 214 may select a data repository from the set of data repositories based on the first set of dimensions. To this end, the selection module 228 may include comparing each of the first set of dimensions with second set of dimensions associated with each of a set of data repositories that may be stored in the repository database 118. In other words, the first set of dimensions may be obtained from the normalized set of data vectors and the second set of dimensions may be obtained from each data repository from the set of data repositories. To compare each of the first set of dimensions with the second set of dimensions, the comparison module 226 may determine for the first set of dimensions a second similarity index relative to the second set of dimensions associated with each of the set of data repositories.

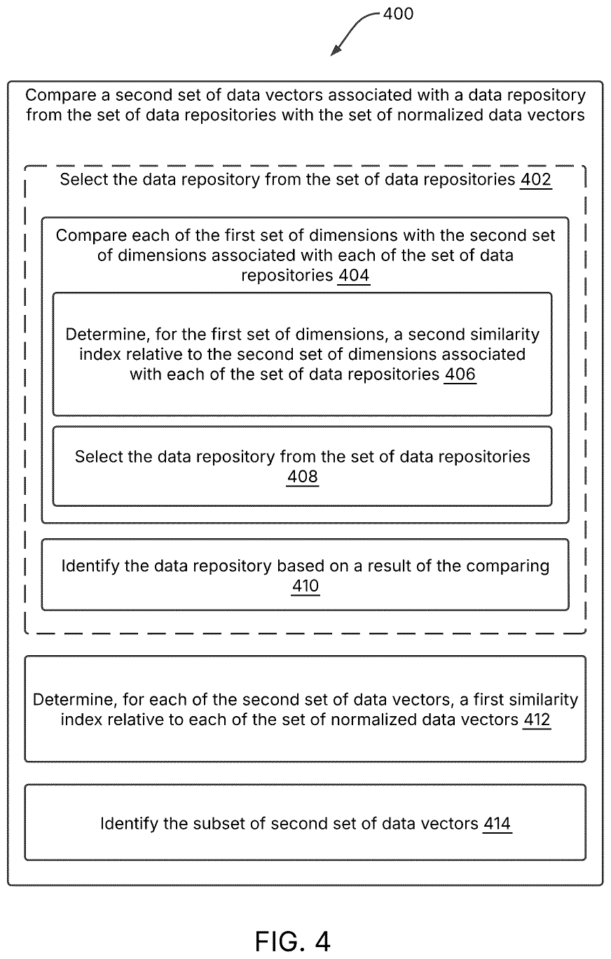

Thereafter, the comparison module 226 may select a data repository from the set of data repositories as the second similarity index of the first set of dimensions relative the second set of dimensions associated with the data repository is the highest. In other words, the data repository for which the second set of dimensions has the highest second similarity index when compared with the remaining set of data repositories get selected. The data repository may include a second set of data vectors that corresponds to a predefined set of compliance policies and a predefined set of industry standards. This is further explained in conjunction with FIG. 4.

The comparison module 226 of the retriever module 214 may compare the second set of data vectors associated with the selected data repository with the set of normalized data vectors. The comparison module 226 may also determine, for each of the second set of data vectors, a first similarity index relative to each of the set of normalized data vectors. The first similarity index may be determined based on one or more of a Euclidean distance or a Cosine distance. The comparison module 226 may then identify a subset of the second set of data vectors, such that, the first similarity index determined for each of the subset of the second set of data vectors is below a predefined threshold. In other words, the subset of the second set of data vectors includes the data vectors from the second set of data vectors that are dissimilar from the set of normalized data vectors.

The retriever module 214 may then retrieve the subset of second set of data vectors from the selected data repository. The subset of the second set of data vectors corresponds to a subset of compliance policies and a subset of industry standards. Since the subset of second set of data vectors are those vectors that are dissimilar to vector representative of the product, it implies that the product fails to comply with the subset of compliance policies and the subset of industry standards. In other words, the product fails to comply with the subset of compliance policies and the subset of industry standards.

Once the subset of the second set of data vectors are identified, the report generation module 222 may generate a report 236. To this end, the data enhancement module 232 in the report generation module 222 may modify the subset of the second set of data vectors into a human readable and understandable format. The techniques used to enhance the readability of the subset of the second set of data vectors may include, but are not limited to Natural Language Processing (NLP) or the like. Upon modifying the subset of the second set of data vectors, the conversion module 234 may generate the report 236 in a predetermined format based on the subset of the second set of data vectors. The predetermined format may include, but is not limited to docx, pdf file, JSON file, or the like. The report 236 may include a set of specifications associated with the subset of compliance policies and the subset of industry standards that the product is required to comply with. Additionally, the report 236 may include a conformance rating for the product. The conformance rating may correspond to a degree of governance and compliance of the product with the data repository. The report 236 may also include recommendations and details as to how a predefined rating (ideal rating) can be achieved

In some embodiments, the memory 106 may additionally include the error handling module 216, the optimization module 218, and the security module 220. The error handling module 216 that may determine the inconsistency in the normalized set of data vectors, in user response or the like and ensures integrity of the normalized set of data vectors. For example, the error handling module 216 may determine whether the user is responding to a question or not. Upon determination of the error, the logging and monitoring module 230 may determine a module, a method or the like causing the error. Further, the logging and monitoring module 230 may track the processing of the first set of data vectors and the execution of the self-evolving questionnaire. In an exemplary scenario, the query module 224 may get stuck and as a result the follow-up question may not be generated. In such cases, the logging and monitoring module 230 may identify the underlying issue.

The optimization module 218 may optimize the storage space in the memory 106. The optimization of the storage space may help in scalability as with the increase of an empty space, a large set of data vectors may be handled without any decline in performance. The security module 220 may protect the sensitive data from an unauthorized access. The security module 220 ensures that only authorized users are able to interact with a set of data vectors, including, but not limited to, the first set of data vectors, the normalized set of data vectors, the second set of data vectors or the like.

It should be noted that all such aforementioned modules 204-234 may be represented as a single module or a combination of different modules. Further, as will be appreciated by those skilled in the art, each of the modules 204-234 may reside, in whole or in parts, on one device or multiple devices in communication with each other. In some embodiments, each of the modules 204-234 may be implemented as dedicated hardware circuit comprising custom application-specific integrated circuit (ASIC) or gate arrays, off-the-shelf semiconductors such as logic chips, transistors, or other discrete components. Each of the modules 204-234 may also be implemented in a programmable hardware device such as a field programmable gate array (FPGA), programmable array logic, programmable logic device, and so forth. Alternatively, each of the modules 204-234 may be implemented in software for execution by various types of processors (e.g., the processor 104). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module, and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for analyzing governance and compliance conformance of products. For example, the exemplary system 100 and the associated computing device 102, may analyze governance and compliance conformance of products by the processes discussed herein. In particular, as will be appreciated by those of ordinary skill in the art, control logic and/or automated routines for performing the techniques and steps described herein may be implemented by the system 100 and the associated computing device 102, either by hardware, software, or combinations of hardware and software. For example, suitable code may be accessed and executed by the one or more processors on the system 100 to perform some or all of the techniques described herein. Similarly, application specific integrated circuits (ASICs) configured to perform some, or all of the processes described herein may be included in the one or more processors on the system 100.

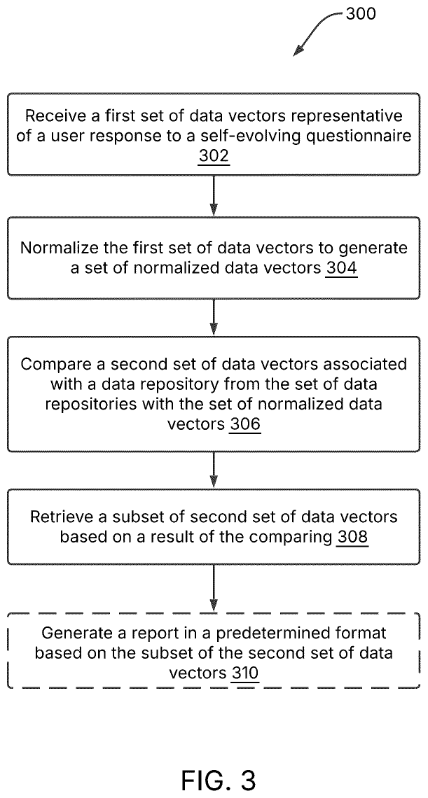

Referring now to FIG. 3, a flowchart of a method 300 for analyzing governance and compliance conformance of products is illustrated, in accordance with some embodiments of the present disclosure. The method 300 may be implemented by the computing device 102 of the system 100. The method 300 may include receiving a first set of data vectors (for example, the first set of data vectors) representative of a user response to a self-evolving questionnaire, at step 302. The user response may correspond to a product. By way of an example, the product may be a DELL ISG®. The DELL ISG® is configured to provide data at rest encryption to meet relevant industry and governmental compliance requirements. The product is configured to pass an internal and external audit. In conjunction with the exemplary questionnaire mentioned in description for FIG. 2, the user response may be determined. For example, a first question may be:

| 1. Which country will your product be shipped to? | | | |
|---|---|---|---|
| a) USA | b) Canada | c) Germany | d) Australia |

The user, for example, may choose option a), i.e., USA. However, the number of options may not be limited to 4. Accordingly, a follow-up question may be generated by the query module 224 based on the user response to the previously asked question, using a predefined Machine Leaning algorithm. For example, the follow-up question may be:

| 2. Which state utilizes this product? | | | |
|---|---|---|---|
| a) Arizona | b) California | c) Alaska | d) Georgia |

The user may choose option b), i.e., California, in the response to the question. In a similar manner, the user may choose the domain as Data at Rest Encryption (DARE®). Now, the user response collectively may be converted into the first set of data vectors that may be stored in the vector database 212 using the disclosed method. Upon storing the first set of data vectors, the sanitization module 208 may then clean the first set of data vectors.

The method 300 may further include normalizing the first set of data vectors to generate a set of normalized data vectors, at step 304. In continuation of the above example, the normalization module 210 may normalize the first set of data vectors stored in the vector database 212 using the existing techniques. The existing techniques may include, but may not be limited to min-max normalization, max-abs normalization, mean normalization, z-score normalization, or the like. The set of normalized data vectors may include a first set of dimensions. The first set of dimensions may include country, state, and domain or industry. Upon normalizing the first set of data vectors at step 304, a data repository may be determined from the repository database 118 using the first set of dimensions. The method used to determine the data repository is further explained in detail in conjunction with FIG. 4.

Thereafter, the method 300 may include comparing a second set of data vectors associated with the data repository with the set of normalized data vectors, at step 306. The second set of data vectors may correspond to a predefined set of compliance policies and a predefined set of industry standards. The data repository may include the predefined set of compliance policies and the predefined set of industry standards. The predefined set of compliance policies and the predefined set of industry standards may be defined by a governmental agency. The product is thus required to comply with the predefined set of compliance policies and the predefined set of industry standards in order to be used in a given country for a given domain or industry. By way of an example, the DELL ISG® may need to comply with the predefined set of compliance policies and the predefined set of industry standards. The data repository selected based on the first set of dimensions for the DELL ISG® may include the following set of predefined compliance policies and industry standards: Management Protocols over TLS 1.3, DNS over TLS 1.3, DNS over HTTPS, Encrypted emails, all connections to services in micro-segmented networks, file protocols (For example, Network File System (NFS), Server Message Block (SMB) or the like), block Protocols (For example, Non-Volatile Memory Express over Fabrics (NVMEoF), Fibre Channel (FC), Internet Small Computer Systems Interface (iSCSI) or the like), object Protocols (For example, Content Addressed Storage (CAS) or the like), Replication and Migration, or Custom data protocols.

Based on a result of the comparing, the method 300 may include retrieving a subset of second set of data vectors, at step 308. The subset of the second set of data vectors may correspond to a subset of compliance policies and a subset of industry standards associated with the data repository. The subset of compliance policies and the subset of industry standards corresponds to those policies and standards with which the product may have failed to comply with. In continuation of the above example, the DELL ISG® may not comply with the subset of compliance policies and the subset of industry standards, which may include DNS over HTTPS, file protocols (For example, Network File System (NFS), Server Message Block (SMB) or the like), object Protocols (For example, and Custom data protocols.

In some embodiments, once the subset of second set of data vectors are retrieved, the method 300 may include generating a report in a predetermined format based on the subset of the second set of data vectors at step 310. The predetermined format may be determined from the first set of data vectors based on the user response. The report may include a conformance rating for the product. The report may also include recommendations and details as to how a predefined rating (ideal rating) can be achieved. In continuation of the example given above, the conformance rating for DELL ISG is determined based on a number of policies and/or standards that DELL ISG is currently not complying with. With the increase in the number of policies and/or standards, the degree of governance and compliance of DELL ISG® relative to the data repository decreases and with the decrease in degree of governance and compliance, the conformance rating of the product decreases.

Referring now to FIG. 4, a detailed flowchart of an exemplary method 400 for comparing a second set of data vectors associated with a data repository from the set of data repositories with the set of normalized data vectors is illustrated, in accordance with some embodiments of the present disclosure. The exemplary method 400 may be implemented by the computing device 102 of the system 100. The method 400 may include selecting a data repository from a set of data repositories, at step 402. In continuation of the example given in description of FIG. 3, the product is DELL ISG®, and the first set of dimensions are the same as described above, but the domain is now ‘password policies.’ It is to be noted that to receive the user response the method already explained in conjunction with FIG. 3 is followed. DELL ISG® is configured to accomplish minimum password configuration capabilities determined by the governmental agency. Once the normalized set of data vectors is obtained from a first set of data vectors generated based on used response, the data repository is determined based on a first set of dimensions in the normalized set of data vectors.

The selection of the data repository is described via steps 404-410. At step 404, each of the first set of dimensions may be compared with the second set of dimensions associated with each of the set of data repositories. By way of an example, the first set of dimensions (for example, country, state, domain or the like determined from the normalized set of data vectors obtained from the first set of data vectors) is compared with the second set of dimensions (for example, country, state, domain or the like associated with each data repository from the set of data repositories). It may be apparent that values stored corresponding to each dimension from the first set of dimensions is compared with values stored corresponding to each dimension from the second set of dimensions. In order to perform the comparison, at step 406, a second similarity index is determined for the first set of dimensions relative to the second set of dimensions associated with each of the set of data repositories. The second similarity index may be determined based on a cosine distance. The cosine distance may be calculated using equation (1) given below:

$$cos ( θ ) = \frac{A \cdot B}{\vert \vert A \vert \vert B \vert \vert} \qquad ( 1 )$$

where, A is an exemplary dimension from the first set of dimensions and B is an exemplary dimension from the second set of dimensions.

Based on the second similarity index determined for each of the set of data repositories, at step 408 the data repository may be selected from the set of data repositories. The data repository has the highest second similarity index corresponding to the first set of dimensions and is thus selected as compared to the remaining set of data repositories from the set of data repositories. At step 410, the data repository may thus be identified based on a result of the comparison. The data repository, as discussed before, includes a second set of data vectors.

Once the data repository is identified, at step 412, for each of the second set of data vectors, a first similarity index relative to each of the set of normalized data vectors is determined. The first similarity index may be determined based on one or more of a Euclidean distance or a cosine distance. Thereafter, at step 414, the subset of second set of data vectors are identified. The subset of the second set of data vectors is identified based on the first similarity index of each of the subset of the second set of data vectors, such that, the data vectors with a similarity index lower than the predefined threshold are added to the subset of the second set of data vectors. This has already been explained in detail in conjunction with FIG. 3.

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

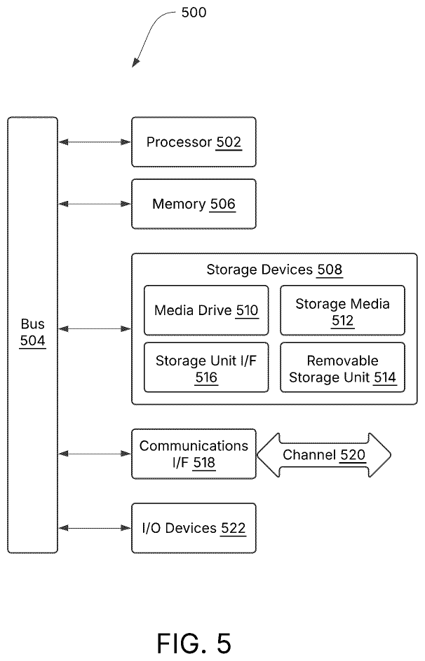

The disclosed methods and systems may be implemented on a conventional or a general-purpose computer system, such as a personal computer (PC) or server computer. Referring now to FIG. 5, an exemplary computing system 500 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 500 may represent, for example, a user device such as a desktop, a laptop, a mobile phone, personal entertainment device, DVR, and so on, or any other type of special or general-purpose computing device as may be desirable or appropriate for a given application or environment. The computing system 500 may include one or more processors, such as a processor 502 that may be implemented using a general or special purpose processing engine such as, for example, a microprocessor, microcontroller or other control logic. In this example, the processor 502 is connected to a bus 504 or other communication medium. In some embodiments, the processor 502 may be an Artificial Intelligence (AI) processor, which may be implemented as a Tensor Processing Unit (TPU), or a graphical processor unit, or a custom programmable solution Field-Programmable Gate Array (FPGA).

The computing system 500 may also include a memory 506 (main memory), for example, Random Access Memory (RAM) or other dynamic memory, for storing information and instructions to be executed by the processor 502. The memory 506 also may be used for storing temporary variables or other intermediate information during execution of instructions to be executed by the processor 502. The computing system 500 may likewise include a read only memory (“ROM”) or other static storage device coupled to bus 504 for storing static information and instructions for the processor 502.

The computing system 500 may also include a storage devices 508, which may include, for example, a media drive 510 and a removable storage interface. The media drive 510 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 512 may include, for example, a hard disk, magnetic tape, flash drive, or other fixed or removable medium that is read by and written to by the media drive 510. As these examples illustrate, the storage media 512 may include a computer-readable storage medium having stored there in particular computer software or data.

In alternative embodiments, the storage devices 508 may include other similar instrumentalities for allowing computer programs or other instructions or data to be loaded into the computing system 500. Such instrumentalities may include, for example, a removable storage unit 514 and a storage unit interface 516, such as a program cartridge and cartridge interface, a removable memory (for example, a flash memory or other removable memory module) and memory slot, and other removable storage units and interfaces that allow software and data to be transferred from the removable storage unit 514 to the computing system 500.

The computing system 500 may also include a communications interface 518. The communications interface 518 may be used to allow software and data to be transferred between the computing system 500 and external devices. Examples of the communications interface 518 may include a network interface (such as an Ethernet or other NIC card), a communications port (such as for example, a USB port, a micro-USB port), Near field Communication (NFC), etc. Software and data transferred via the communications interface 518 are in the form of signals which may be electronic, electromagnetic, optical, or other signals capable of being received by the communications interface 518. These signals are provided to the communications interface 518 via a channel 520. The channel 520 may carry signals and may be implemented using a wireless medium, wire or cable, fiber optics, or other communications medium. Some examples of the channel 520 may include a phone line, a cellular phone link, an RF link, a Bluetooth link, a network interface, a local or wide area network, and other communications channels.

The computing system 500 may further include Input/Output (I/O) devices 522. Examples may include, but are not limited to a display, keypad, microphone, audio speakers, vibrating motor, LED lights, etc. The I/O devices 522 may receive input from a user and also display an output of the computation performed by the processor 502. In this document, the terms “computer program product” and “computer-readable medium” may be used generally to refer to media such as, for example, the memory 506, the storage devices 508, the removable storage unit 514, or signal(s) on the channel 520. These and other forms of computer-readable media may be involved in providing one or more sequences of one or more instructions to the processor 502 for execution. Such instructions, generally referred to as “computer program code” (which may be grouped in the form of computer programs or other groupings), when executed, enable the computing system 500 to perform features or functions of embodiments of the present invention.

In an embodiment where the elements are implemented using software, the software may be stored in a computer-readable medium and loaded into the computing system 500 using, for example, the removable storage unit 514, the media drive 510 or the communications interface 518. The control logic (in this example, software instructions or computer program code), when executed by the processor 502, causes the processor 502 to perform the functions of the invention as described herein.

Various embodiments provide method and system for analyzing governance and compliance conformance of products. The disclosed method and system may receive a first set of data vectors representative of a user response to a self-evolving questionnaire. The user response corresponds to a product. Further, the disclosed method and system may normalize the first set of data vectors to generate a set of normalized data vectors. The set of normalized data vectors includes a first set of dimensions Further, the disclosed method and system may compare a second set of data vectors associated with a data repository from the set of data repositories with the set of normalized data vectors. The second set of data vectors corresponds to a predefined set of compliance policies and a predefined set of industry standards. Further, the disclosed method and system may retrieve a subset of second set of data vectors based on a result of the comparing. The subset of the second set of data vectors correspond to a subset of compliance policies and a subset of industry standards associated with the data repository. The product fails to comply with the subset of compliance policies and the subset of industry standards.

Thus, the disclosed techniques try to overcome the problem of analyzing the governance and compliance conformance of products. The disclosed techniques functions as an intelligent assessment engine that will integrate with a deployment engine. This integration will ensure the adoption of all necessary security components during the product development process and provide verified reports of security governance and security compliance, which will be displayed via a reporting engine. This approach achieves an intelligent and integrated security framework and implementation. The techniques may also integrate with the existing product (such as developed product), the product under development or the product under design stage. As a result, the techniques provide operational efficiency by streamlining processes and reducing the expenses associated with the management of security governance and security compliance. This ensures that the organization meets all legal and regulatory obligations and that too with good efficiency. The techniques may also provide efficient retrieval of relevant data repository and analyze governance and compliance conformance relevant to the product.

Further, the techniques identify and mitigate security risks and vulnerabilities to ensure data protection. This is achieved by establishes policies and controls to protect sensitive data from breaches and misuse. The techniques also provide an enhanced user engagement by generating a follow-up question based on the previous question. This encourages regular review and updating of security measures, leading to a stronger security posture over time.

The techniques may also generate a report corresponding to the subset of predefined compliance policies and the subset of industry standards, the product fails to comply. The report may then be used to make sure that subsequent versions of the product are fully compliant with the required compliance policies and industry standards. The techniques make development of a product completely agnostic of the location, industry, or domain for which a product is being developed, as a near exhaustive list of required compliance policies and industry standards is automatically detected and product features or requirements are then compared with these compliance policies and industry standards for a full compliance. Thus, by adopting a security and compliance framework, organizations can take a proactive and organized approach to safeguard their assets and meet their legal obligations. This further reduces risks and enhances their overall security and compliance posture. Collectively, the above enables enhanced trust at the customers' end by demonstrating to customers, partners, and stakeholders that the organization is committed to protecting sensitive information and maintaining compliances.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system for analyzing governance and compliance conformance of products. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for analyzing governance and compliance conformance of products, wherein the method comprises:
receiving, by a processor, a first set of data vectors representative of a user response to a self-evolving questionnaire, wherein the user response corresponds to a product;
normalizing, by the processor, the first set of data vectors to generate a set of normalized data vectors, wherein the set of normalized data vectors comprises a first set of dimensions;
comparing, by the processor, a second set of data vectors associated with a data repository from the set of data repositories with the set of normalized data vectors, wherein the second set of data vectors corresponds to a predefined set of compliance policies and a predefined set of industry standards; and
retrieving, by the processor, a subset of second set of data vectors based on a result of the comparing, wherein the subset of second set of data vectors correspond to a subset of compliance policies and a subset of industry standards associated with the data repository, and wherein the product fails to comply with the subset of compliance policies and the subset of industry standards.

2. The method as claimed in claim 1, wherein the method further comprises generating a report in a predetermined format based on the subset of the second set of data vectors.

3. The method as claimed in claim 2, wherein the report comprises a set of specifications required to comply with the subset of compliance policies and the subset of industry standards.

4. The method as claimed in claim 2, wherein the report comprises:
a conformance rating for the product, wherein the conformance rating corresponds to a degree of compliance of the product with the data repository; and
recommendations to achieve a predefined rating.

5. The method as claimed in claim 1, wherein comparing the second set of data vectors associated with the data repository comprises:
determining, for each of the second set of data vectors, a first similarity index relative to each of the set of normalized data vectors; and
identifying the subset of the second set of data vectors, wherein the first similarity index of each of the subset of the second set of data vectors is below a predefined threshold.

6. The method as claimed in claim 5, wherein the first similarity index is determined based on one or more of a Euclidean distance or a Cosine distance.

7. The method as claimed in claim 1, wherein each of the set of data repositories comprises an associated second set of dimensions.

8. The method as claimed in claim 7, further comprises selecting the data repository from the set of data repositories, wherein selecting the data repository comprises:
comparing each of the first set of dimensions with the second set of dimensions associated with each of the set of data repositories; and
identifying the data repository based on a result of the comparing.

9. The method as claimed in claim 8, wherein comparing each of the first set of dimensions with the second set of dimensions comprises:
determining, for the first set of dimensions, a second similarity index relative to the second set of dimensions associated with each of the set of data repositories; and
selecting the data repository from the set of data repositories, wherein the second similarity index of the first set of dimensions relative to the data repository is the highest.

10. A system for analyzing governance and compliance conformance of products, the system comprising:
a processor; and
a memory communicatively coupled to the processor, wherein the memory stores processor instructions, which when executed by the processor, cause the processor to:
receive a first set of data vectors representative of a user response to a self-evolving questionnaire, wherein the user response corresponds to a product;
normalize the first set of data vectors to generate a set of normalized data vectors, wherein the set of normalized data vectors comprises a first set of dimensions;
compare a second set of data vectors associated with a data repository from the set of data repositories with the set of normalized data vectors, wherein the second set of data vectors corresponds to a predefined set of compliance policies and a predefined set of industry standards; and
retrieve a subset of second set of data vectors based on a result of the comparing, wherein the subset of second set of data vectors correspond to a subset of compliance policies and a subset of industry standards associated with the data repository, and wherein the product fails to comply with the subset of compliance policies and the subset of industry standards.

11. The system as claimed in claim 10, wherein the processor instructions, on execution, cause the processor to generate a report in a predetermined format based on the subset of the second set of data vectors.

12. The system as claimed in claim 11, wherein the report comprises a set of specifications required to comply with the subset of compliance policies and the subset of industry standards.

13. The system as claimed in claim 11, wherein the report comprises:
a conformance rating for the product, wherein the conformance rating corresponds to a degree of compliance of the product with the data repository; and
recommendations to achieve a predefined rating.

14. The system as claimed in claim 10, wherein comparing the second set of data vectors associated with the data repository cause the processor to:
determine for each of the second set of data vectors, a first similarity index relative to each of the set of normalized data vectors; and
identify the subset of second set of data vectors, wherein the first similarity index of each of the subset of second set of data vectors is below a predefined threshold.

15. The system as claimed in claim 14, wherein the first similarity index is determined based on one or more of a Euclidean distance or a Cosine distance.

16. The system as claimed in claim 10, wherein each of the set of data repositories comprises an associated second set of dimensions.

17. The system as claimed in claim 16, further comprises selecting the data repository from the set of data repositories, wherein selecting the data repository cause the processor to:
compare each of the first set of dimensions with the second set of dimensions associated with each of the set of data repositories; and
identify the data repository based on a result of the comparing.

18. The system as claimed in claim 17, wherein comparing each of the first set of dimensions with the second set of dimensions cause the processor to:
determine, for the first set of dimensions, a second similarity index relative to the second set of dimensions associated with each of the set of data repositories; and
select the data repository from the set of data repositories, wherein the second similarity index of the first set of dimensions relative to the data repository is the highest.

19. A non-transitory computer-readable medium storing computer-executable instructions for analyzing governance and compliance conformance of products, the computer-executable instructions configured for:
receiving a first set of data vectors representative of a user response to a self-evolving questionnaire, wherein the user response corresponds to a product;
normalizing the first set of data vectors to generate a set of normalized data vectors, wherein the set of normalized data vectors comprises a first set of dimensions;
comparing a second set of data vectors associated with a data repository from the set of data repositories with the set of normalized data vectors, wherein the second set of data vectors corresponds to a predefined set of compliance policies and a predefined set of industry standards; and
retrieving a subset of the second set of data vectors based on a result of the comparing, wherein the subset of second set of data vectors correspond to a subset of compliance policies and a subset of industry standards associated with the data repository, and wherein the product fails to comply with the subset of compliance policies and the subset of industry standards.
